(19) United States
(12) Patent Application Publication
(10) Pub. No.: US 2026/0257677 A1
(43) Pub. Date: Sep. 3, 2026

(54) TRAVEL CONTROL DEVICE, TRAVEL CONTROL METHOD, AND STORAGE MEDIUM

(71) Applicant: HONDA MOTOR CO., LTD., Tokyo (JP)

(72) Inventor: Daichi Inoue, Tokyo (JP)

(21) Appl. No.: 19/549,028

(22) Filed: Feb. 25, 2026

(30) Foreign Application Priority Data
Feb. 28, 2025 (JP) 2025-030962

(51) Int. Cl. B60W 30/12; G06V 20/56

(52) U.S. Cl. CPC B60W 30/12; G06V 20/588; B60W 2552/10; B60W 2552/53; B60W 2556/40

(57) ABSTRACT

A travel control device recognizes a surrounding situation including first markings that define a travel lane of a vehicle on the basis of an output of a detection device that detects a surrounding situation of the vehicle, recognizes second markings that define a lane near the vehicle from map information, determines whether or not the first markings match the second markings, selects any one of the first markings and the second markings when it is determined that the markings do not match, and executes travel control of the vehicle on the basis of the selected marking. A center line of a lane defined by the first markings and a center line of a lane defined by the second markings are compared in terms of a degree of deviation therebetween. When the degree of deviation is equal to or greater than a threshold, the first markings are selected.

### CROSS-REFERENCE TO RELATED APPLICATION

Priority is claimed on Japanese Patent Application No. 2025-030962, filed Feb. 28, 2025, the content of which is incorporated herein by reference.

### BACKGROUND

### Field of the Invention

The present invention relates to a travel control device, a travel control method, and a storage medium.

### Description of the Related Art

Recently, efforts to provide access to sustainable transportation systems have been increasingly active in consideration of vulnerable individuals among participants in transportation. For this realization, research and development efforts are focused on further improving the safety and convenience of transportation through research and development related to automated driving technology. In this regard, conventional technology in which a lateral position of a host vehicle is decided using at least one of a lateral position of the vehicle based on satellite information and map information and a lateral position of the vehicle based on camera information, and a target steering angle is calculated on the basis of curvature of a travel lane at a position of the host vehicle and the decided lateral position of the host vehicle is known (see, for example, Japanese Patent No. 6415629).

### SUMMARY

Meanwhile, in conventional automated driving technologies, because there are various road situations in real environments, there remains room for further study regarding travel control in a case where one of a marking obtained from map information and a marking obtained from an output of a detection device such as a camera becomes unrecognizable during travel. Thus, there is a problem because appropriate travel control may not be executed according to a road situation.

In order to solve the above problem, an objective of the present application is to provide a travel control device, a travel control method, and a storage medium that enable more appropriate travel control to be executed on the basis of a road situation. Also, the present invention contributes to the development of sustainable transportation systems.

A travel control device, a travel control method, and a storage medium according to the present invention adopt the following configurations.
(1): According to an aspect of the present invention, there is provided a travel control device including: a first recognizer configured to recognize a surrounding situation including first markings that define a travel lane of a vehicle on the basis of an output of a detection device that detects a surrounding situation of the vehicle; a second recognizer configured to recognize second markings that define a lane near the vehicle from map information on the basis of position information of the vehicle; a determiner configured to determine whether or not the first markings match the second markings; a selector configured to select any one of the first markings and the second markings when the determiner determines that the first markings do not match the second markings; and a travel controller configured to execute travel control of the vehicle on the basis of the marking selected by the selector, wherein the selector compares a center line of a lane defined by the first markings located on left and right sides of the vehicle and a center line of a lane defined by the second markings located on the left and right sides of the vehicle in terms of a degree of deviation therebetween when one of the second markings defining the travel lane of the vehicle and located on the left and right sides of the vehicle is discontinued partway in a travel direction of the vehicle, and selects the first markings when the degree of deviation is equal to or greater than a threshold.
(2): In the above-described aspect (1), the map information stores information about the center line of the lane defined by the second markings located on the left and right sides of the vehicle for a segment subsequent to a point at which the one of the second markings located on the left and right sides of the vehicle is discontinued partway.
(3): In the above-described aspect (1), the travel lane of the vehicle is a main lane in the map information, and one of the second markings located on the left and right sides of the vehicle continues for a segment subsequent to a point at which the marking is discontinued partway in the travel direction of the vehicle.
(4): In the above-described asect (1), the travel lane of the vehicle is a lane for which the map information does not include information about a branch lane, a merge lane, or a lane increase/decrease segment.
(5): In the above-described aspect (1), the selector compares the center line of the lane defined by the first markings located on the left and right sides of the vehicle and the center line of the lane defined by the second markings located on the left and right sides of the vehicle in terms of the degree of deviation therebetween, within a detection range of the detection device recognized by the first recognizer.
(6): In the above-described aspect (1), the selector compares the center line of the lane defined by the first markings located on the left and right sides of the vehicle and the center line of the lane defined by the second markings located on the left and right sides of the vehicle in terms of the degree of deviation therebetween, within a range in which the center line of the lane defined by the second markings is not discontinued.
(7): In the above-described aspect (1), the selector compares the center line of the lane defined by the first markings located on the left and right sides of the vehicle and the center line of the lane defined by the second markings located on the left and right sides of the vehicle in terms of the degree of deviation therebetween, when a connection point connected to a merge lane and a connection point connected to a branch lane are located in the travel lane.
(8): In the above-described aspect (7), the selector compares the center line of the lane defined by the first markings located on the left and right sides of the vehicle and the center line of the lane defined by the second markings located on the left and right sides of the vehicle in terms of the degree of deviation therebetween, when a connection point connected to a merge lane is located in the travel direction of the vehicle in the travel lane, and a connection point connected to a branch lane is located within a predetermined distance ahead of the connection point as viewed from the vehicle.
(9): According to an aspect of the present invention, there is provided a travel control method including: recognizing, by a computer, a surrounding situation including first markings that define a travel lane of a vehicle on the basis of an output of a detection device that detects a surrounding situation of the vehicle; recognizing, by the computer, second markings that define a lane near the vehicle from map information on the basis of position information of the vehicle; determining, by the computer, whether or not the first markings match the second markings; selecting, by the computer, any one of the first markings and the second markings when it is determined that the first markings do not match the second markings; executing, by the computer, travel control of the vehicle on the basis of the selected marking; and comparing, by the computer, a center line of a lane defined by the first markings located on left and right sides of the vehicle and a center line of a lane defined by the second markings located on the left and right sides of the vehicle in terms of a degree of deviation therebetween when one of the second markings defining the travel lane of the vehicle and located on the left and right sides of the vehicle is discontinued partway in a travel direction of the vehicle, and selecting the first markings when the degree of deviation is equal to or greater than a threshold.
(10): According to an aspect of the present invention, there is provided a computer-readable non-transitory storage medium storing a program for causing a computer to: recognize a surrounding situation including first markings that define a travel lane of a vehicle on the basis of an output of a detection device that detects a surrounding situation of the vehicle; recognize second markings that define a lane near the vehicle from map information on the basis of position information of the vehicle; determine whether or not the first markings match the second markings; select any one of the first markings and the second markings when it is determined that the first markings do not match the second markings; execute travel control of the vehicle on the basis of the selected marking; and compare a center line of a lane defined by the first markings located on left and right sides of the vehicle and a center line of a lane defined by the second markings located on the left and right sides of the vehicle in terms of a degree of deviation therebetween when one of the second markings defining the travel lane of the vehicle and located on the left and right sides of the vehicle is discontinued partway in a travel direction of the vehicle, and select the first markings when the degree of deviation is equal to or greater than a threshold.

According to the above-described aspects (1) to (10), it is possible to execute more appropriate travel control on the basis of a road situation.

### BRIEF DESCRIPTION OF THE DRAWINGS

FIG. 1 is a configuration diagram of a vehicle system including a travel control device according to an embodiment.

FIG. 2 is a diagram of a functional configuration of a first controller and a second controller.

FIG. 3 is an explanatory diagram of travel control of a vehicle according to the embodiment.

FIG. 4 is a diagram showing an example of a situation in which any one of device-based markings and map-based markings is selected by a selector.

FIG. 5 is a flowchart showing an example of a flow of a process executed by an automated driving control device.

### DESCRIPTION OF EMBODIMENTS

Hereinafter, embodiments of a travel control device, a travel control method, and a storage medium of the present invention will be described with reference to the drawings. Hereinafter, an embodiment in which the travel control device is applied to an automated driving vehicle will be described as an example. For example, automated driving is a process for executing travel control by automatically controlling one or both of a vehicle’s speed and steering. For example, the above-described travel control may include various types of travel control such as an adaptive cruise control system (ACC), a traffic jam pilot (TJP), a lane keeping assistance system (LKAS), an automated lane change (ALC), and a collision mitigation brake system (CMBS). Moreover, in automated driving vehicles, travel control based on a manual operation of a user (for example, an occupant) of a vehicle (so-called manual driving) may be executed. Although a case where left-hand traffic regulations are applied will be described below, it is only necessary to reverse the left and right when right-hand traffic regulations are applied.

### Overall Configuration

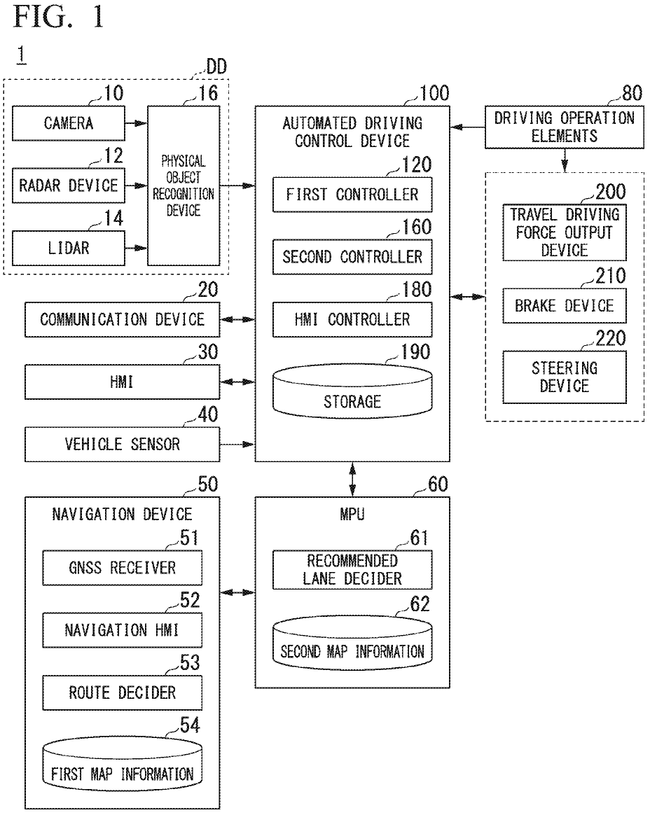

FIG. 1 is a configuration diagram of a vehicle system 1 including a travel control device according to an embodiment. A vehicle (hereinafter referred to as a vehicle M) on which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a battery (power storage) such as a secondary battery or a fuel cell is discharged.

For example, the vehicle system 1 includes a camera 10, a radar device 12, a light detection and ranging (LIDAR) 14, a physical object recognition device 16, a communication device 20, a human machine interface (HMI) 30, a vehicle sensor 40, a navigation device 50, a map positioning unit (MPU) 60, driving operation elements 80, an automated driving control device 100, a travel driving force output device 200, a brake device 210, and a steering device 220. Such devices and equipment are connected to each other by a multiplex communication line such as a controller area network (CAN) communication line, a serial communication line, a wireless communication network, or the like. In addition, the configuration shown in FIG. 1 is merely an example and some of the constituent elements may be omitted or other constituent elements may be further added. A combination of the camera 10, the radar device 12, the LIDAR 14, and the physical object recognition device 16 is an example of a “detection device DD.” The HMI 30 is an example of an “output device.” The automated driving control device 100 is an example of a “travel control device.”

For example, the camera 10 is a digital camera using a solid-state imaging element such as a charge-coupled device (CCD) or a complementary metal oxide semiconductor (CMOS). The camera 10 is attached to any location on the vehicle on which the vehicle system 1 is mounted. When the view in front of the vehicle is imaged, the camera 10 is attached to an upper part of a front windshield, a rear surface of a rearview mirror, a front part of a vehicle body, or the like. When the view to the rear of the vehicle is imaged, the camera 10 is attached to an upper part of a rear windshield, a back door, or the like. When the views to the sides of the vehicle are imaged, the camera 10 is attached to door mirrors or the like. For example, the camera 10 periodically and iteratively images the surroundings of the vehicle M. The camera 10 may be a stereo camera.

The radar device 12 radiates radio waves (radar) such as millimeter waves around the vehicle M and detects at least a position of a physical object (a distance from the physical object and a direction of the physical object) by detecting radio waves (reflected waves) reflected by the physical object near the vehicle M. The radar device 12 is attached to any location on the vehicle M. The radar device 12 may detect a position and a speed of the physical object in a frequency-modulated continuous wave (FM-CW) scheme.

The LIDAR 14 radiates light to the vicinity of the vehicle M and measures scattered light. The LIDAR 14 detects a distance from a physical object on the basis of time from light emission to light reception. The radiated light is, for example, pulsed laser light. The LIDAR 14 is attached to any location on the vehicle M.

The physical object recognition device 16 performs a sensor fusion process on detection results from some or all of the camera 10, the radar device 12, and the LIDAR 14 to recognize a position, type, speed, and the like of the physical object. The physical object recognition device 16 outputs a recognition result to the automated driving control device 100. The physical object recognition device 16 may output detection results of the camera 10, the radar device 12, and the LIDAR 14 to the automated driving control device 100 as they are. In this case, the physical object recognition device 16 may be omitted from the configuration of the vehicle system 1 (the detection device DD).

The communication device 20, for example, communicates with another vehicle located in the vicinity of the vehicle M, a terminal device of a user using the vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 outputs various types of information to occupants (including the driver) of the vehicle M and receives input operations from the occupants. The HMI 30 includes, for example, various types of display devices, a speaker, a buzzer, a touch panel, a switch, a key, a microphone, and the like.

The vehicle sensor 40 includes a vehicle speed sensor configured to detect the speed of the vehicle M, an acceleration sensor configured to detect acceleration, a yaw rate sensor configured to detect a yaw rate (e.g., a rotational angular velocity around a vertical axis passing through the center of gravity of the vehicle M), and a direction sensor configured to detect a direction of the vehicle M. Moreover, the vehicle sensor 40 may include a position sensor configured to detect the position of the vehicle. The position sensor is, for example, a sensor configured to acquire position information (longitude/latitude information) from a Global Positioning System (GPS) device. Moreover, the position sensor may be a sensor configured to acquire position information using a global navigation satellite system (GNSS) receiver 51 of the navigation device 50. The vehicle sensor 40 may derive the speed of the vehicle from a position information difference (i.e., a distance) at a predetermined time in the position sensor. A detection result of the vehicle sensor 40 is output to the automated driving control device 100.

For example, the navigation device 50 includes the GNSS receiver 51, a navigation HMI 52, and a route decider 53. The navigation device 50 stores first map information 54 in a storage device such as a hard disk drive (HDD) or a flash memory. The GNSS receiver 51 identifies a position of the vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, a key, and the like. The GNSS receiver 51 may be provided in the vehicle sensor 40. The navigation HMI 52 may be partly or wholly shared with the above-described HMI 30. For example, the route decider 53 decides a route (hereinafter referred to as a route on a map) from the position of the vehicle M identified by the GNSS receiver 51 (or any input position) to a destination input by the occupant using, for example, the navigation HMI 52 with reference to the first map information 54 or the like. The first map information 54 is, for example, information in which a road shape is expressed by a link indicating a road and nodes connected by the link. The first map information 54 may include point of interest (POI) information, and the like. The route on the map is output to the MPU 60. The navigation device 50 may provide route guidance using the navigation HMI 52 on the basis of the route on the map. The navigation device 50 may transmit a current position and a destination to a navigation server via the communication device 20 and acquire a route equivalent to the route on the map from the navigation server. The navigation device 50 outputs the decided route on the map to the MPU 60.

The MPU 60 includes, for example, a recommended lane decider 61, and holds second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62. The recommended lane decider 61 decides in what lane numbered from the left the vehicle will travel. The recommended lane decider 61 decides the recommended lane so that the vehicle can travel along a reasonable route for traveling to a branching destination when there is a branch point on the route on the map.

The second map information 62 has higher accuracy than the first map information 54. The second map information 62 includes, for example, the number of lanes, a type and shape of a road marking (hereinafter referred to as a marking), information about a center of a lane or information about a road boundary, and the like. The second map information 62 may include information about whether or not the road boundary is a boundary including a structure through which the vehicle M cannot pass (including crossing or contacting). Examples of the structure include guardrails, curbs, median strips, fences, and the like. The term “passage is impossible” may include the presence of steps that are low enough to pass if the vehicle is allowed to vibrate, which would not normally occur. Moreover, the second map information 62 may include road shape information, traffic regulation information, address information (addresses and postal codes), facility information, parking lot information, telephone number information, and the like. The road shape information is, for example, the curvature of a road (which may be rephrased as a radius of curvature; the same is true below), a curvature variation for each predetermined distance, a road width, a gradient, and the like.

Moreover, the second map information 62 may include information about a line (center line) indicating a center of a lane. The center line is a line located at a center between left and right markings. This center line may also be located in a lane in which one of the left or right markings defining the lane is discontinued. Furthermore, the second map information 62 may store information about the center line of the lane defined by the markings for a segment subsequent to a point at which a marking is discontinued (or a segment previous to the point at which the marking is discontinued). Moreover, the second map information 62 may store information about road branch points, merge points, lane increase/decrease points, and the like. At the branch point, information about a branch lane and a main lane may be included, and at the merge point, information about a merge lane and a main lane may be included.

The second map information 62 may be updated as needed by the communication device 20 communicating with an external device. The first map information 54 and the second map information 62 may be provided integrally as map information. The map information may be stored in the storage 190.

The driving operation elements 80 include, for example, a steering wheel, an accelerator pedal, and a brake pedal. Moreover, the driving operation elements 80 may include a shift lever, a variant steering wheel, a joystick, and other operation elements. For example, an operation detector configured to detect an amount of operation on the operation element by the occupant, or the presence or absence of operation is attached to each operation element among the driving operation elements 80. The operation detector detects, for example, a steering angle and steering torque of the steering wheel, an amount of depression of the accelerator pedal or the brake pedal, and the like. Also, the operation detector outputs the detection result to the automated driving control device 100, or to one or all of the travel driving force output device 200, the brake device 210, and the steering device 220.

The automated driving control device 100 executes various types of driving control belonging to automated driving with respect to the vehicle M. The automated driving control device 100 includes, for example, a first controller 120, a second controller 160, an HMI controller 180, and a storage 190. Each of the first controller 120, the second controller 160, and the HMI controller 180 is implemented, for example, by a hardware processor such as a central processing unit (CPU) executing a program (software). Moreover, some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The above-described program may be pre-stored in a storage device (a storage device including a non-transitory storage medium) such as an HDD or a flash memory of the automated driving control device 100 or may be stored in a removable storage medium such as a digital versatile disc (DVD), a compact disc- read-only memory (CD-ROM), or a memory card and installed in the storage device of the automated driving control device 100 when the storage medium (the non-transitory storage medium) is mounted on a drive device, a card slot, or the like.

The storage 190 may be implemented by the above-described various types of storage devices, an electrically erasable programmable read-only memory (EEPROM), a read-only memory (ROM), a random-access memory (RAM), or the like. The storage 190 stores, for example, various types of information in embodiments, programs, and the like. Moreover, the storage 190 may store map information (e.g., the first map information 54 and the second map information 62).

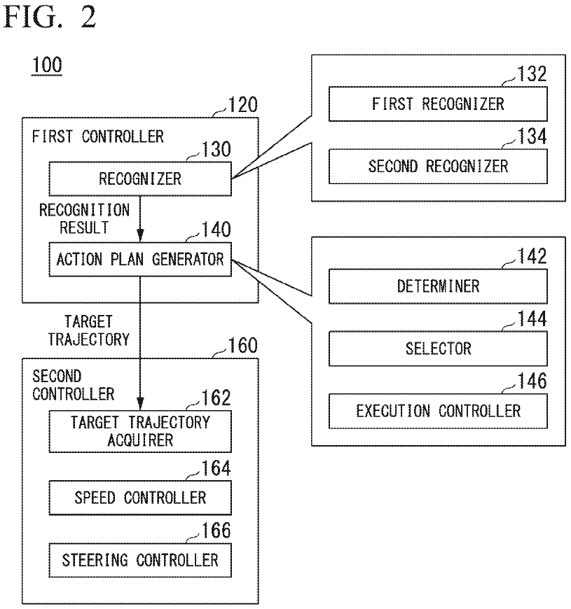

FIG. 2 is a diagram of a functional configuration of the first controller 120 and the second controller 160. The first controller 120 includes, for example, a recognizer 130 and an action plan generator 140. The first controller 120 implements, for example, a function of artificial intelligence (AI) and a function of a predetermined model in parallel. For example, an “intersection recognition” function may be implemented by executing intersection recognition based on deep learning or the like and recognition based on previously given conditions (signals, road signs, or the like, with which pattern matching is possible) in parallel and performing comprehensive evaluation by assigning scores to both recognitions. Thereby, the reliability of automated driving is secured. Moreover, the first controller 120 executes control related to automated driving of the vehicle M on the basis of, for example, instructions from the MPU 60, the HMI controller 180, or the like.

The recognizer 130 recognizes a surrounding situation of the vehicle M on the basis of a recognition result of the detection device DD (information input from the camera 10, the radar device 12, and the LIDAR 14 via the physical object recognition device 16). For example, the recognizer 130 recognizes states of the position, speed, acceleration, and the like of a physical object located in the vicinity of the vehicle M (within a predetermined distance from the vehicle M). Physical objects include, for example, other vehicles (nearby vehicles), traffic participants traveling on the road (such as pedestrians and bicycles), road structures, and other physical objects such as obstacles located in a nearby area. The road structures include, for example, road signs, traffic signals, railroad crossings, curbs, median strips, guardrails, fences, and the like. The position of the physical object, for example, is recognized as a position on absolute coordinates with a representative point (the center of gravity, the center of a drive shaft, or the like) of the vehicle M as the origin, and is used for control. The position of the physical object may be indicated by a representative point such as the center of gravity or a corner of the physical object or may be indicated by an area that has been represented. The “state” of the physical object may include, for example, the acceleration or jerk of the mobile object, or the “action state” (e.g., whether or not another vehicle is changing lanes or is about to change lanes) when the physical object is a mobile object such as another vehicle.

Moreover, the recognizer 130 includes, for example, a first recognizer 132 and a second recognizer 134. Details of the functions of these constituent elements will be described below.

The action plan generator 140 generates an action plan for causing the vehicle M to travel according to automated driving on the basis of a recognition result of the recognizer 130 or the like. For example, the action plan generator 140 generates a future target trajectory along which the vehicle M will automatically travel (independently of the driver’s operation) so that the vehicle M can generally travel in the recommended lane decided by the recommended lane decider 61 and further take an action for a surrounding situation of the vehicle M on the basis of a nearby road shape, or the like based on the recognition result of the recognizer 130 or a current position of the vehicle M acquired from map information. For example, the target trajectory includes a speed element. For example, the target trajectory is represented by sequentially arranging points (trajectory points) at which the vehicle M is required to arrive. The trajectory points are points at which the vehicle M is required to arrive for each predetermined traveling distance (e.g., about several meters [m]) in a distance along a road. In addition, a target speed and target acceleration for each predetermined sampling time (e.g., about 0.x [sec] where x is a decimal number) are generated as parts of the target trajectory. Moreover, the trajectory point may be a position where the vehicle M is required to arrive at the sampling time for each predetermined sampling time. In this case, information of the target speed and the target acceleration is represented by an interval between the trajectory points.

The action plan generator 140 may set an automated driving event when the target trajectory is generated. The events include, for example, a constant speed travel event in which the vehicle M travels in the same lane at a constant speed, a tracking travel event for causing the vehicle M to track another vehicle located within a predetermined distance (e.g., within 100 [m]) in front of the vehicle M and closest to the vehicle M, a lane change event for causing the vehicle M to make a lane change from a host-vehicle lane to an adjacent lane, a branching event for causing the vehicle M to move to a lane in a destination direction at a branch point of a road, a merging event for causing the vehicle M to move to a main lane at a merge point, a takeover event for ending automated driving and switching driving to manual driving, and the like. Moreover, the events may include, for example, an overtaking event in which the vehicle M first makes a lane change to an adjacent lane, overtakes the preceding vehicle in the adjacent lane, and then makes a lane change to the original lane again, an avoidance event for causing the vehicle M to perform at least one of braking and steering to avoid an obstacle in front of the vehicle M, and the like.

Moreover, the action plan generator 140, for example, may change an event already decided for a current segment to another event or set a new event for the current segment, in accordance with a surrounding situation of the vehicle M recognized when the vehicle M is traveling. Moreover, the action plan generator 140 may change an event already set for the current segment to another event or set a new event for the current segment, in accordance with an operation of the occupant on the HMI 30. The action plan generator 140 generates a target trajectory according to the set event.

Moreover, the action plan generator 140 includes, for example, a determiner 142, a selector 144, and an execution controller 146. The execution controller 146 and the second controller 160 are examples of a “travel controller.” The functions of these constituent elements will be described in detail below.

The second controller 160 controls the travel driving force output device 200, the brake device 210, and the steering device 220 so that the vehicle M passes through the target trajectory generated by the action plan generator 140 at a scheduled time.

The second controller 160 includes, for example, a target trajectory acquirer 162, a speed controller 164, and a steering controller 166. The target trajectory acquirer 162 acquires information about a target trajectory (trajectory points) generated by the action plan generator 140 and causes a memory (not shown) to store the information. The speed controller 164 controls the travel driving force output device 200 or the brake device 210 on the basis of the speed element associated with the target trajectory stored in the memory. The steering controller 166 controls the steering device 220 in accordance with a degree of curvature of the target trajectory stored in the memory. The processes of the speed controller 164 and the steering controller 166, for example, are implemented by a combination of feedforward control and feedback control. As an example, the steering controller 166 executes a combination of feedforward control according to the curvature of the road in front of the vehicle M and feedback control based on the deviation from the target trajectory.

Returning to FIG. 1, the HMI controller 180 notifies the occupant of predetermined information through the HMI 30. The predetermined information includes, for example, information related to traveling of the vehicle M such as information about the state of the vehicle M and information about travel control. The information about the state of the vehicle M includes, for example, a speed, an engine speed, a shift position, and the like of the vehicle M. Moreover, information about the travel control includes, for example, the presence or absence of the execution of travel control based on automated driving, information for asking about whether or not to start the automated driving, information about a travel control situation based on the automated driving, information about an automation level, information for prompting the occupant to perform driving when driving is switched from the automated driving to the manual driving, and the like. Moreover, the predetermined information may include information irrelevant to traveling of the vehicle M, such as content (e.g., movies) stored in a storage medium such as a TV program or a DVD. Moreover, the predetermined information may include, for example, information about the current position and destination in automated driving and the remaining amount of fuel of the vehicle M. The HMI controller 180 may output the information received by the HMI 30 to the communication device 20, the navigation device 50, the first controller 120, and the like.

Moreover, the HMI controller 180 may output inquiry information for the occupant, the processing results of the first controller 120 and the second controller 160, and the like to the HMI 30. Moreover, the HMI controller 180 may transmit various types of information to be output to the HMI 30 to the terminal device used by the user of the vehicle M via the communication device 20.

The travel driving force output device 200 outputs a travel driving force (torque) for enabling the vehicle M to travel to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the second controller 160 or information input from the accelerator pedal of the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the brake pedal of the driving operation element 80 so that brake torque according to a braking operation is output to each wheel. The brake device 210 may include a mechanism configured to transfer the hydraulic pressure generated according to an operation on the brake pedal to the cylinder via a master cylinder as a backup. In addition, the brake device 210 is not limited to the above-described configuration and may be an electronically controlled hydraulic brake device configured to control an actuator in accordance with information input from the second controller 160 and transfer the hydraulic pressure of the master cylinder to the cylinder.

For example, the steering device 220 includes a steering ECU and an electric motor. For example, the electric motor changes directions of steerable wheels by applying a force to a rack and pinion mechanism. The steering ECU drives the electric motor in accordance with the information input from the second controller 160 or the information input from the steering wheel of the driving operation element 80 to change the directions of the steerable wheels.

### Recognizer and Action Plan Generator

Next, functions of the recognizer 130 (the first recognizer 132 and the second recognizer 134) and the action plan generator 140 (the determiner 142, the selector 144, and the execution controller 146) will be described in detail.

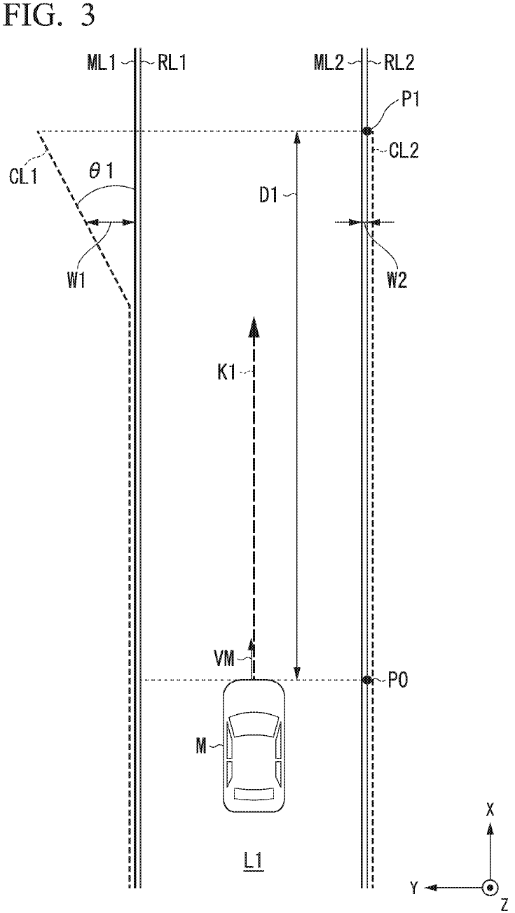

FIG. 3 is an explanatory diagram of travel control of the vehicle M according to the embodiment. In the example of FIG. 3, device-based markings CL1 and CL2 recognized by the detection device DD, map-based markings ML1 and ML2 obtained from map information (e.g., second map information 62) on the basis of position information of the vehicle M, and actual markings RL1 and RL2 actually drawn on a road surface (travel path) are shown. For example, a lane L1 is defined by the actual markings RL1 and RL2. The lane L1 shown in FIG. 3 is a lane in which travel is possible in an extension direction (an X-axis direction in the drawing). Hereinafter, when the device-based markings CL1 and CL2 are not distinguished from each other, they may be simply referred to as “device-based markings CL.” When the map-based markings ML1 and ML2 are not distinguished from each other, they may be simply referred to as “map-based markings ML.” When the actual markings RL1 and RL2 are not distinguished from each other, they may be simply referred to as “actual markings RL.” Moreover, in the scene shown in FIG. 3, the vehicle M is traveling on the lane L1 at a speed VM. As necessary, the lane L1 on which the vehicle M travels may be referred to as a “travel lane L1.” The device-based marking CL is an example of a “first marking,” and the map-based marking ML is an example of a “second marking.”

In the example of FIG. 3, the first recognizer 132 recognizes the surrounding situation of the vehicle M on the basis of an output of the detection device DD that detects the surrounding situation (external environment) of the vehicle M. For example, the first recognizer 132 recognizes markings on the left and right sides of the vehicle M that define the travel lane L1 of the vehicle M (left and right markings as viewed from the vehicle M) as the device-based markings CL1 and CL2, on the basis of images captured by a camera 10 (hereinafter, camera images). Although the device-based markings CL1 and CL2 in front of the vehicle M are shown in the example of FIG. 3, device-based markings CL1 and CL2 on the sides and rear of the vehicle M may also be recognized.

For example, the first recognizer 132 analyzes a camera image, extracts edge points having a large luminance difference from adjacent pixels in the image and connects the edge points to recognize the device-based markings CL1 and CL2 on the image plane. Moreover, the first recognizer 132 converts the positions of the device-based markings CL1 and CL2 based on the position of a representative point of the vehicle M into those of a vehicle coordinate system (e.g., XY plane coordinates in FIG. 3).

Moreover, the first recognizer 132 may recognize, for example, the curvatures of the device-based markings CL1 and CL2. Moreover, the first recognizer 132 may recognize curvature variations of the device-based markings CL1 and CL2. Moreover, the first recognizer 132 may recognize the curvature or curvature variation of the lane defined by the device-based markings CL1 and CL2 by averaging the curvatures or curvature variations of the device-based markings CL1 and CL2. The first recognizer 132 may recognize the device-based markings CL1 and CL2 on the basis of an output of the detection device DD (e.g., the radar device 12 or the LIDAR 14) other than the camera 10 and may correct the device-based markings CL1 and CL2 obtained from the camera image. Moreover, the first recognizer 132 may recognize a center line of the lane L1 defined by the device-based markings CL1 and CL2.

The second recognizer 134, for example, recognizes markings of lanes near the vehicle M from the map information (the first map information 54 and the second map information 62) on the basis of the position of the vehicle M detected by the vehicle sensor 40 or the GNSS receiver 51. For example, the second recognizer 134 recognizes markings on the left and right sides of the vehicle M that define the travel lane L1 of the vehicle M as the map-based markings ML1 and ML2 with reference to the map information on the basis of the position information of the vehicle M.

Moreover, the second recognizer 134 may recognize, from the map information, the curvature or the curvature variation of each of the map-based markings ML1 and ML2. Moreover, the second recognizer 134 may recognize the curvature or the curvature variation of the travel lane L1 by averaging the curvatures or the curvature variations of the map-based markings ML1 and ML2. Moreover, the second recognizer 134 may acquire, from the map information, information about a center line of the lane L1 defined by the map-based markings ML1 and ML2. Moreover, the second recognizer 134 may recognize portions where the map-based markings ML1 and ML2 on the left and right sides of the vehicle M are discontinued (lost) partway.

The determiner 142 determines whether or not the device-based markings CL recognized by the first recognizer 132 match the map-based markings ML recognized by the second recognizer 134. “Match” may include a predetermined allowable error range. For example, in a segment (determination target range) from the current position of the vehicle M (a point P0 in the drawing) to a position (a point P1 in the drawing) separated in the travel direction (forward direction) by a distance (determination target distance) D1, the determiner 142 determines whether or not the device-based marking CL1 defining the left side of the travel lane L1 as viewed from the vehicle M matches the map-based marking ML1, and determines whether or not the device-based marking CL2 defining the right side of the travel lane L1 matches the map-based marking ML2. Here, the distance D1, for example, may be a distance from a farthest point of the device-based markings CL1 and CL2 that can be recognized in the detection device DD by the first recognizer 132, a distance according to the road shape or the speed VM of the vehicle M, or may be a fixed distance.

For example, the determiner 142 compares elements of at least one type of the positions, extension directions (angles), curvatures, and curvature variations of the device-based marking CL1 and the map-based marking ML1 in the determination target range based on the distance D1, and the like. For example, the determiner 142 superimposes the device-based marking CL1 and the map-based marking ML1 on the basis of a position of a representative point of the vehicle M in the vehicle coordinate system plane (XY plane), compares their lateral positions (a lane-width direction and a Y-axis direction in the drawing), and acquires a deviation amount W1. The deviation amount W1 may be a maximum deviation amount in the determination target range or may be an average value.

Moreover, the determiner 142 may compare the extension directions of the device-based marking CL1 and the map-based marking ML1 to acquire a marking deviation angle θ1. The deviation angle θ1 may be a maximum deviation angle in the determination target range or may be an average angle. Moreover, the determiner 142 may compare the curvatures or the curvature variations of the device-based marking CL1 and the map-based marking ML1 to acquire a degree (magnitude) of a difference. Also, the determiner 142 may obtain a degree of deviation on the basis of the deviation amount W1, the deviation angle θ1, and the degree of difference between the curvatures or curvature variations. In this case, for example, the degree of deviation increases as the deviation amount W1 increases, as the deviation angle θ1 increases, and as the degree of difference between the curvatures (curvature variations) increases.

Moreover, as in the comparison of the left-side markings, the determiner 142 may compare elements of at least one type of the positions (deviation amounts W2 in the drawing), deviation angles, curvatures, and curvature variations of the device-based marking CL2 and the map-based marking ML2, as a comparison of the right-side markings in the determination target range, and may acquire a degree of deviation. Moreover, the determiner 142 may acquire the degree of deviation between the device-based marking CL and the map-based marking ML by comprehensively determining a result of comparing the markings on the left side of the vehicle M (in other words, the travel lane L1) and a result of comparing the markings on the right side thereof.

For example, the determiner 142 determines that the device-based markings CL match the map-based markings ML when both the degree of deviation between the left-side markings and the degree of deviation between the right-side markings are less than a threshold, and determines that the device-based markings CL do not match the map-based markings ML when at least one of them is equal to or greater than the threshold.

The selector 144 selects at least one of the device-based markings CL and the map-based markings ML for use in travel control of the vehicle M on the basis of a determination result of the determiner 142. For example, when the determiner 142 determines that the device-based markings CL match the map-based markings ML, the selector 144 selects one or both of the device-based marking CL and the map-based marking ML that have been predetermined. Moreover, when the determiner 142 determines that the device-based markings CL do not match the map-based markings ML and a predetermined condition is satisfied, the selector 144 selects one of the device-based markings CL and the map-based markings ML. Details of the function of the selector 144 will be described below. In addition, when the determiner 142 determines that the device-based markings CL do not match the map-based markings ML and the predetermined condition is not satisfied, the selector 144 may select none of the markings.

The execution controller 146 executes control (travel control) of the vehicle M on the basis of the recognition results of the first recognizer 132 and the second recognizer 134, the determination result of the determiner 142, the selection result of the selector 144, and the like. For example, the execution controller 146 decides travel control for the vehicle M on the basis of the above-described recognition results, determination result, selection result, and the like, and generates a target trajectory based on the decided travel control. “Deciding travel control” may include, for example, deciding the content (type) of travel control and deciding whether or not to execute travel control (or whether to suppress the travel control). Moreover, “executing travel control” may include continuing travel control that is already being executed, in addition to switching and executing the content of travel control. “Suppressing travel control” includes not only preventing travel control from being executed but also lowering the travel control mode (automation level).

Here, the travel control includes a first travel mode and a second travel mode in which a degree of driving assistance is lower than that in the first travel mode or a task load imposed on the occupant of the vehicle M is greater than that in the first travel mode. A lower degree of driving assistance means, for example, a lower automation rate in the travel control. The lower automation rate indicates, for example, that a degree to which the automated driving control device 100 controls steering or speed of the vehicle M is low (i.e., a degree to which the driver needs to intervene in steering or acceleration/deceleration operations is high). A large task load on the occupant includes, for example, a case where the number of tasks imposed on the occupant is large and/or a case where a task is difficult. Examples of the tasks include monitoring the surroundings of the vehicle M and the occupant operating the driving operation elements 80. Operations on the driving operation elements 80 includes, for example, a state in which the driver grips a steering wheel (hereinafter, a hands-on state). In addition, the travel control may further include a third travel mode or the like in which the degree of driving assistance is lower than that in the second travel mode or the task load on the occupant of the vehicle M is greater than that in the second travel mode. Moreover, a travel mode with the lowest degree of driving assistance or the greatest task load on the occupant of the vehicle M may be a fully manual travel mode (a mode in which travel control is not executed).

For example, in the first travel mode, there are no tasks for the occupant (or the tasks are easiest), and travel control (e.g., ACC, LKAS, ALC, TJP, CMBS, or the like) is permitted in a state in which the occupant of the vehicle M is not gripping the steering wheel (hereinafter, a hands-off state). Moreover, in the second travel mode, tasks imposed on the occupant may include, for example, monitoring the surroundings of the vehicle M and maintaining the hands-on state.

For example, when it is determined that the device-based markings CL match the map-based markings ML during execution of the first travel mode (e.g., travel control in the hands-off state), the execution controller 146 continues the first travel mode. For example, when the LKAS for traveling at the center of the travel lane L1 is executed as the first travel mode, the execution controller 146 generates a target trajectory (e.g., a target trajectory K1 shown in FIG. 3) for traveling at the center of the lane L1 on the basis of one or both of the device-based markings CL1 and CL2 and the map-based markings ML1 and ML2 selected by the selector 144, and causes the second controller 160 to execute control so that traveling is performed along the generated target trajectory K1. For example, when one of the device-based markings CL and the map-based markings ML is selected by the selector 144, the execution controller 146 generates the target trajectory K1 on the basis of left and right positions of the selected marking. Moreover, when information about a center line of the lane L1 is acquired from the map information, the execution controller 146 generates the target trajectory K1 so that the center of gravity (or center) of the vehicle M travels along the center line. When both the device-based markings CL and the map-based markings ML are selected by the selector 144, the execution controller 146 moves (corrects) the position of one marking (e.g., the map-based marking ML) to match the position of the other marking (e.g., the device-based marking CL) and generates the target trajectory K1 using information about the moved marking.

Moreover, when it is determined that the device-based markings CL match the map-based markings ML in the determination target range during execution of the second travel mode (e.g., driving in the hands-on state), the execution controller 146 may perform control for switching the travel mode from the second travel mode to the first travel mode. In this case, when performing the switching control, the execution controller 146 may cause the HMI 30 to output information indicating that switching is possible or information for asking about whether to switch (or information for proposing switching) for the occupant and may switch the travel mode when information indicating permission for switching is received from the occupant. Moreover, after an instruction to switch the travel mode to the first travel mode is issued via the HMI 30, the execution controller 146 may switch the travel mode from the second travel mode to the first travel mode at a timing when it is determined that the device-based markings CL match the map-based markings ML.

Moreover, when it is determined that the device-based markings CL do not match the map-based markings ML in the determination target range and a predetermined condition is not satisfied, the execution controller 146 may suppress travel control based on the first travel mode. For example, when it is determined that the device-based markings CL do not match the map-based markings ML during execution of the first travel mode, the execution controller 146 executes travel control to switch the travel mode from the first travel mode to the second travel mode. Moreover, when it is determined that the device-based markings CL do not match the map-based markings ML during execution of the second travel mode, the execution controller 146 may perform control so that a process for switching the travel mode to the first travel mode cannot be executed.

Moreover, when it is determined that the device-based markings CL do not match the map-based markings ML in the determination target range during execution of the first travel mode and a predetermined condition is satisfied, the execution controller 146 continues the first travel mode on the basis of any one of the device-based markings CL and the map-based markings ML selected by the selector 144. Moreover, when the above-described condition is satisfied during execution of the second travel mode, the execution controller 146 may perform control to switch the travel mode from the second travel mode to the first travel mode on the basis of any one of the device-based markings CL and the map-based markings ML selected by the selector 144.

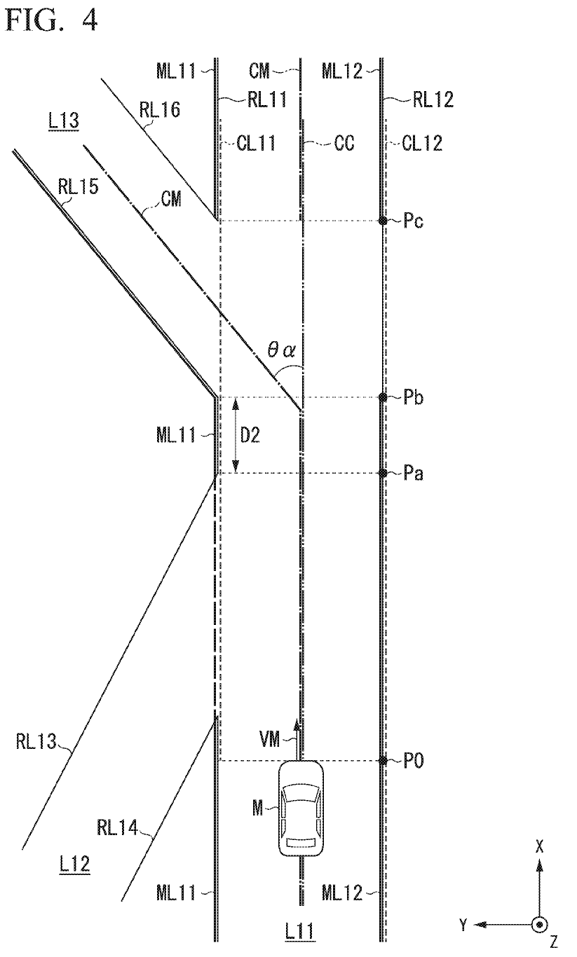

Next, the above-described “predetermined condition” and the above-described marking selection process of the selector 144 will be described. FIG. 4 is a diagram showing an example of a situation in which any one of the device-based markings CL and the map-based markings ML is selected by the selector 144. In the example of FIG. 4, a road shape including lanes L11 to L13 is shown. The lane L11 is defined by actual markings RL11 and RL12, the lane L12 is defined by actual markings RL13 and RL14, and the lane L13 is defined by actual markings RL15 and RL16. Moreover, in the example of FIG. 4, the lane L12 is a merge lane that merges into the lane L11, which is a main lane, and the lane L13 is a branch lane that branches from the lane L11. Hereinafter, the lane L11 may be referred to as a “travel lane L11,” the lane L12 may be referred to as a “merge lane L12,” and the lane L13 may be referred to as a “branch lane L13.” Moreover, in the example of FIG. 4, it is assumed that the vehicle M is traveling in the lane L11 at a speed VM in the extension direction (the X-axis direction in the drawing).

Moreover, in the example of FIG. 4, the first recognizer 132 recognizes device-based markings CL11 and CL12 corresponding to the actual markings RL11 and RL12 that define the lane L11, and the second recognizer 134 recognizes map-based markings ML11 and ML12 of the lane L11. Moreover, in the example of FIG. 4, the first recognizer 132 recognizes a center line (hereinafter, a device-based center line) CC of the lane L11 defined by the device-based markings CL11 and CL12, and the second recognizer 134 recognizes, from the map information, a center line (hereinafter, a map-based center line) CM of the lane L11 defined by the map-based markings ML11 and ML12. Although the map information stores map-based markings that define the lanes L12 and L13, the map-based markings ML11 and ML12 that define the lane L11 in which the vehicle M is traveling is shown in FIG. 4 for convenience of description. Moreover, because the vehicle M traveling in the main lane (lane L11) cannot travel in the merge lane L12 with respect to a portion of the map-based marking ML11 that is connected to the merge lane L12, the map-based marking ML11 may extend as it is. Moreover, in the example of FIG. 4, it is assumed that the map information does not include information about branching, merging, or a lane increase/decrease segment.

For example, in road shapes in which branch lanes or merge lanes exist, or road shapes in which the number of lanes increases or decreases, particularly at connection (junction) points of multiple lanes or at points where the number of lanes changes, a part of the map-based markings ML may be discontinued (lost) and it is impossible to recognize the discontinued part of the map-based markings ML. Therefore, as shown in FIG. 4, when the vehicle M is traveling in the main lane (lane L11), the degree of deviation between the device-based marking CL and the map-based marking ML becomes equal to or greater than a threshold, resulting in a state in which the markings do not match, and thus the first travel mode may not be executable (or may not be continued).

In the example of FIG. 4, the merge lane L12 is connected to the travel lane L11 of the vehicle M, and a connection point (a point Pb shown FIG. 4) connected to the branch lane L13 is located at a point ahead of the vehicle M (in the travel direction) by a distance D2 from the connection point (a point Pa shown in FIG. 4). In such a road situation where merging or branching exists in lanes (lanes L12 and L13) adjacent to the travel lane L11 of the vehicle M, a center line of the merge lane L12 or the branch lane L13 overlaps the center line of the lane L11. Because such overlapping information is not stored in a distinguishable manner in the map information, the map-based marking ML12 on the right side of the main lane (lane L11) may be discontinued at a branch or merge point. In the example of FIG. 4, the map-based marking ML12 on the opposite side from the map-based marking ML11, which is connected to the lanes L11, L12, and L13, is discontinued from a position of the point Pb onward.

Moreover, a part of the map-based marking ML11 is connected to the lane L11 and extends along the branch lane L13 (more specifically, along the actual marking RL15) in which the vehicle M can travel. For example, if the actual marking RL11 is worn or faint at a connection portion, because the accuracy of recognition by the camera 10 decreases, an erroneous connection to the branch side is more likely to occur. Thus, in the conventional technology, there is a possibility that a road shape in which the merge lane L12 merges into the main lane (lane L11) and the main lane extends toward the branch lane L13 side will be recognized and there is a possibility that it will be erroneously recognized that the branch lane L13 side is the lane in which the vehicle M should travel. Accordingly, in the conventional technology, in the above-described road situation, the behavior of the vehicle M may become unstable, or deceleration control (curve deceleration) for traveling in the branch lane L13 or the like may malfunction. Furthermore, in a road shape such as that shown in FIG. 4, because it is determined that the device-based markings CL do not match the map-based markings ML, there are cases where the first travel mode cannot be executed (or continued).

Therefore, when the device-based markings CL do not match the map-based markings and the predetermined condition as shown in FIG. 4 is satisfied in the embodiment, any one of the device-based markings CL and the map-based markings ML is selected by the selector 144, and driving control of the vehicle M is executed on the basis of the selected marking. Here, predetermined conditions include, for example, the following conditions (1) to (4), but are not limited thereto, and some of the conditions may be omitted.
(1) The map-based markings ML11 and ML12 in the left-right direction (lateral direction) at the current position of the vehicle M (the point P0 shown in FIG. 4) are recognizable (in the example of FIG. 4, they are assumed to be recognizable).
(2) The map-based marking ML is discontinued and a range in which the map-based center line CM is not discontinued is equal to or greater than a predetermined range (in the example of FIG. 4, the right map-based marking ML12 is discontinued at a point Pb, but the map-based center line CM, although erroneously connected to the left branch lane L13, continues without discontinuity).
(3) Information about a branch lane, a merge lane, or a lane increase/decrease segment is not stored in the map information with respect to the travel lane L11 of the vehicle M (in the example of FIG. 4, it is assumed that the above-described condition is not stored).
(4) Within a detection range (for example, a determination target range) of a detection device DD such as the camera 10, the device-based markings CL do not match the map-based markings ML (in the example of FIG. 4, they are assumed not to match).

For example, when the map-based marking ML is discontinued in front of the vehicle M in a road shape that satisfies the above-described conditions (1) to (4), it is difficult to determine whether the map information is incorrect (difficulty in detecting map differences is high). Therefore, in a situation satisfying the above-described conditions, the selector 144 determines whether or not the map information is incorrect on the basis of a degree of deviation between the map-based center line CM and the device-based center line CC and determines the device-based marking CL as the correct marking when the map information is determined to be incorrect. Thereby, for example, when travel control based on the map-based marking ML is being executed, it is possible to suppress the unsteady behavior of the vehicle M (in other words, make the behavior of the vehicle M more stable) in a situation where the vehicle M attempts to travel in another direction (for example, the extension direction of the branch lane L13) during traveling in the road-following direction (for example, the extension direction of the lane L11) at least under LKAS control or the like.

For example, when one of the map-based markings ML11 and ML12 located on the left and right sides of the vehicle M that define the travel lane L11 of the vehicle M is discontinued partway in the travel direction of the vehicle M, the selector 144 compares a center line (device-based center line CC) of the lane defined by the device-based markings CL11 and CL12 located on the left and right sides as viewed from the vehicle M and a center line (map-based center line CM) of the lane defined by the map-based markings ML11 and ML12 located on the left and right sides of the vehicle M in terms of a degree of deviation therebetween. Also, when the degree of deviation is equal to or greater than a threshold, the selector 144 selects the device-based markings CL11 and CL12. Thereby, when one of the map-based markings ML11 and ML12 is discontinued, it is possible to determine whether or not the device-based marking CL is correct on the basis of the map-based center line CM. Thereby, compared with simply selecting the device-based marking CL merely because the map-based marking ML is discontinued, more appropriate determination can be made, and more appropriate travel control can be executed using information about the marking selected based on the determination.

In the example of FIG. 4, the selector 144 derives an angle formed between the device-based center line CC and the map-based center line CM as a deviation angle θα, determines whether or not a degree of deviation corresponding to the derived deviation angle θα is equal to or greater than the threshold, and selects the device-based marking CL when the degree of deviation is equal to or greater than the threshold. In addition, one of the conditions for the map-based center line CM of a comparison target may be, for example, that it is a map-based center line CM extending toward the branch lane L13 side, or that a joining point (a point from which the deviation angle θα is derived) between the device-based center line CC and the map-based center line CM is within a predetermined distance from the connection point Pa or Pb, or that the distance D2 is within a predetermined distance range. The predetermined distance range may be, for example, a fixed distance range, or a distance range that includes the merge lane L12 and the branch lane L13 within the detection range of the detection device DD.

When the degree of deviation between the device-based center line CC and the map-based center line CM is less than the threshold, the selector 144 may select a predetermined marking of the device-based marking CL and the map-based marking ML, even though a part of the map-based marking ML12 is discontinued as shown in FIG. 4, because the deviation between the center lines is small.

Moreover, as shown in FIG. 4, when one of the left and right map-based markings is not discontinued and the device-based markings CL do not match the map-based markings ML, the selector 144 does not select any marking and may suppress execution (or continuation) of the first travel mode (driving control).

In the embodiment, when the above-described condition (2) is satisfied, the selector 144 can more accurately determine whether or not the device-based marking CL is correct because the map-based center line CM is not discontinued by comparing the device-based center line CC and the map-based center line CM in terms of the degree of deviation therebetween and can select a more appropriate marking.

Moreover, in the embodiment, instead of the above-described condition (3), the selector 144 may use the condition that the travel lane of the vehicle M is a main lane in the map information, and one of the map-based markings ML11 and ML12 located on the left and right sides of the vehicle M continues for a segment subsequent to a point at which the marking is discontinued partway in the travel direction of the vehicle M (a lane continues as the main lane for a segment subsequent to the point Pb at which the marking is discontinued). In the example of FIG. 4, although the map-based marking ML12 from the point Pb to the point Pc is discontinued, the map-based marking ML12 (as well as the map-based marking ML11 and the map-based center line CM) is present for a segment subsequent to the point Pc, such that the main lane continues. Because the process of the selector 144 described above is based on the premise that the travel lane L11 of the vehicle M is a main lane, including this condition makes it possible to more accurately determine whether or not the device-based marking CL is the correct marking.

Moreover, the selector 144, for example, may perform a comparison of the degree of deviation between the device-based center line CC and the map-based center line CM within the detection range of the detection device DD by the first recognizer 132. Thus, it is possible to more accurately determine whether or not the device-based marking CL is the correct marking without performing a process such as virtually extending a line beyond the detection range for the comparison.

Moreover, the selector 144 may compare the device-based center line CC and the map-based center line CM in terms of the degree of deviation therebetween within a range in which the map-based center line CM is not discontinued. By using such a range in which the map-based center line CM is not discontinued, it is possible to more accurately determine whether or not the device-based marking CL is the correct marking.

Moreover, as shown in FIG. 4, when a connection point (merge end point) connected to a merge lane L12 is located in the travel lane L11 of the vehicle M, and thereafter a connection point (branch start point) connected to a branch lane L13 is located, the selector 144 may compare the device-based center line CC and the map-based center line CM in terms of the degree of deviation therebetween. For example, when a connection point (merge end point) connected to the merge lane L12 is located in the travel direction of the vehicle M in the travel lane L11 of the vehicle M, and a connection point (branch start point) connected to the branch lane L13 is located within a predetermined distance ahead of the connection point (merge end point) as viewed from the vehicle M, the selector 144 may compare the device-based center line CC and the map-based center line CM in terms of the degree of deviation therebetween. In such a road situation in which merging and branching exist within a predetermined distance, because there is a high possibility that the map-based marking ML is stored as being discontinued in the map information, it is possible to more accurately determine whether or not the device-based marking CL is the correct marking by comparing the device-based center line CC and the map-based center line CM in terms of the degree of deviation therebetween in such a situation.

Moreover, in the embodiment, the HMI controller 180 may output information on the marking selected by the selector 144 as described above and information about a reason why that marking is selected to the HMI 30, in addition to information about the execution situation of travel control.

### Modification Examples

Although a case where there is a branch lane after a merge lane has been described in the above-described embodiment, a similar process may be applied to a lane increase/decrease segment (for example, a segment in which the number of lanes increases within a predetermined distance after the number of lanes decreases) or to other road shapes (for example, branching after the number of lanes decreases or the like). Moreover, in the above-described embodiment, a similar process may be applied not only when a map-based marking on an opposite side from a connection of the merge lane or the branch lane is discontinued, but also when a map-based marking of the connection side is discontinued. Moreover, in the above-described embodiment, a similar process may be applied to a road shape in which a merge lane is connected on one side of the left and right map-based markings and a branch lane is connected on the other side, rather than a road shape in which both a merge lane and a branch lane are connected on the same side.

Moreover, in the embodiment, when the map information includes information about branching, merging, or a lane increase/decrease segment, it is determined whether or not the device-based markings CL match the map-based markings ML in consideration of changes (differences) in markings (or road shapes) corresponding to information items. Moreover, in a situation in which one of the left and right map-based markings of the vehicle M is discontinued, when information about branching, merging, or a lane increase/decrease segment is stored in the map information, the selector 144 may select the map-based marking ML on the assumption that the discontinuity is caused due to branching, merging, or the lane increase/decrease segment.

Moreover, in the embodiment, when both of the left and right map-based markings are discontinued, execution of the first travel mode may be suppressed by determining the device-based markings CL do not match the map-based markings ML.

Moreover, in the above-described embodiment, it is determined whether the device-based markings CL match the map-based markings ML match, but it may be determined whether or not they deviate instead of determining whether or not they match. In this case, the determiner 142 determines that they deviate when the above-described degree of deviation is equal to or greater than a threshold, and determines that they do not deviate when the degree of deviation is less than the threshold.

### Processing Flow

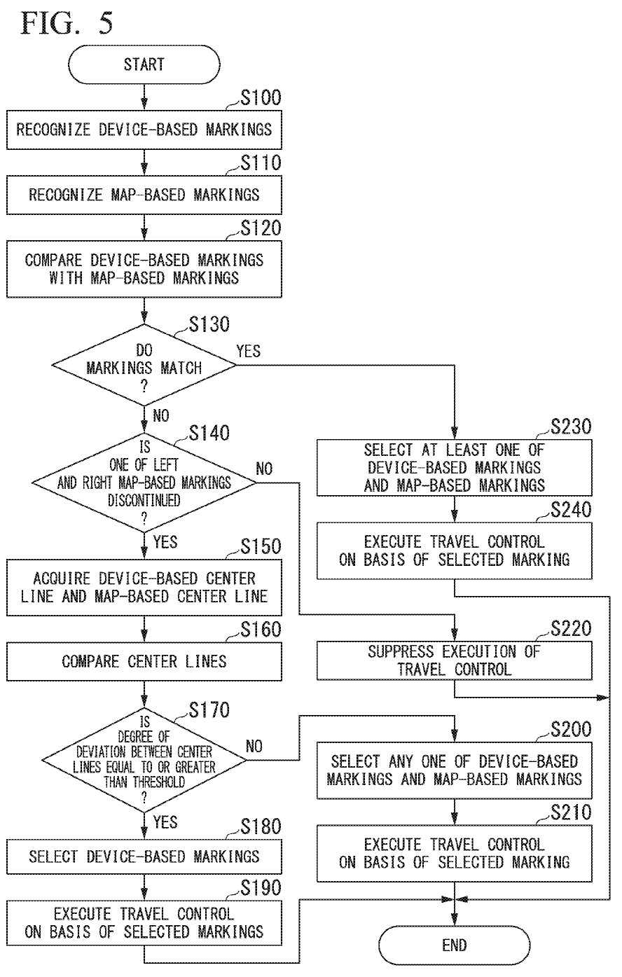

Hereinafter, a process executed by the automated driving control device 100 according to the embodiment will be described. FIG. 5 is a flowchart showing an example of a flow of the process executed by the automated driving control device 100. In the following description, among the processes executed by the automated driving control device 100, a driving control process mainly based on a marking recognition state will be described. The process to be described below may be iteratively executed at predetermined timings or at predetermined cycles, and may be iteratively executed while driving control by the automated driving control device 100 is being performed.

In the example of FIG. 5, the first recognizer 132 recognizes markings (device-based markings) located near the vehicle M on the basis of an output of the detection device DD that detects a surrounding situation of the vehicle M (step S100). Subsequently, the second recognizer 134 recognizes markings (map-based markings) located near the vehicle M from the map information with reference to map information on the basis of position information of the vehicle M (step S110). Subsequently, the determiner 142 compares the device-based markings and the map-based markings (step S120) and determines whether or not the device-based markings match the map-based markings (step S130).

When it is determined that the device-based markings do not match the map-based markings, the selector 144 determines whether or not one of the left and right map-based markings (map-based markings in the travel direction of the vehicle M) of the travel lane of the vehicle M is discontinued (step S140). When it is determined that one of the left and right map-based markings is discontinued, the selector 144 acquires a device-based center line and a map-based center line (step S150) and compares the acquired center lines (step S160). Subsequently, the selector 144 determines whether or not a degree of deviation between the device-based center line and the map-based center line as a result of the comparison is equal to or greater than a threshold (step S170). When it is determined that the degree of deviation is equal to or greater than the threshold, the selector 144 selects the device-based markings (step S180). Subsequently, the execution controller 146 generates a target trajectory on the basis of the selected markings (device-based markings) and causes the second controller 160 to execute travel control (for example, travel control in the first travel mode) (or continue the travel control that is being executed) on the basis of the generated target trajectory (step S190).

Moreover, in the processing of step S170, when it is determined that the degree of deviation between the device-based center line CC and the map-based center line CM is not equal to or greater than the threshold, the selector 144 selects one of the device-based markings CL and the map-based markings ML (step S200). Subsequently, the execution controller 146 generates a target trajectory on the basis of the selected marking and causes the second controller 160 to execute driving control (for example, travel control in the first travel mode) (or continue the travel control that is being executed) on the basis of the generated target trajectory (step S210).

Moreover, in the processing of step S140, when it is determined that one of the left and right map-based markings is not discontinued (or when neither of the left and right map-based markings is discontinued or when both are discontinued), the selector 144 does not select a marking and the execution controller 146 suppresses execution of travel control (step S220). In addition, in the processing of step S140, when it is determined that one of the left and right map-based markings is not discontinued, the selector 144 may compare the device-based markings with the map-based markings, instead of the processing of step S220, proceed to the processing of step S180 when the degree of deviation is equal to or greater than the threshold, and proceed to the processing of step S200 when the degree of deviation is less than the threshold.

Moreover, when it is determined that the device-based markings match the map-based markings in the processing of step S130, the selector 144 selects at least one of the device-based markings and the map-based markings (step S230). Subsequently, the execution controller 146 generates a target trajectory on the basis of the selected marking and causes the second controller 160 to execute driving control on the basis of the generated target trajectory (step S240). Thereby, the process of the present flowchart ends.

According to the above-described embodiment, the automated driving control device 100 (an example of a travel control device) includes: the first recognizer 132 configured to recognize a surrounding situation including device-based markings (an example of first markings) that define a travel lane of the vehicle M on the basis of an output of the detection device DD that detects a surrounding situation of the vehicle M; the second recognizer 134 configured to recognize map-based markings (an example of second markings) that define a lane near the vehicle M from map information on the basis of position information of the vehicle M; the determiner 142 configured to determine whether or not the device-based markings match the map-based markings; the selector 144 configured to select any one of the device-based markings and the map-based markings when the determiner 142 determines that the device-based markings do not match the map-based markings; and a travel controller (the execution controller 146 and the second controller 160) configured to execute travel control of the vehicle M on the basis of the marking selected by the selector 144, wherein the selector 144 compares a center line of a lane defined by the device-based markings located on left and right sides of the vehicle M and a center line of a lane defined by the map-based markings located on the left and right sides of the vehicle M in terms of a degree of deviation therebetween when one of the map-based markings defining the travel lane of the vehicle and located on the left and right sides of the vehicle M is discontinued partway in a travel direction of the vehicle M, and selects the device-based markings when the degree of deviation is equal to or greater than a threshold, whereby it is possible to execute more appropriate travel control on the basis of a road situation. Also, it is possible to contribute to the development of a sustainable transportation system.

Moreover, according to the embodiment, for example, when the travel lane of the vehicle M is a main lane and an adjacent lane is a branch lane, and a map-based marking on a side opposite to a side connected to the branch lane within the left and right map-based markings corresponding to the travel lane is discontinued near a connection point, it is possible to accurately determine whether or not the device-based markings are correct by comparing a center line of a lane defined by the left and right map-based markings and a center line of a lane defined by the left and right device-based markings in terms of a degree of deviation therebetween. Moreover, according to the embodiment, when a map-based marking is discontinued, it is possible to more accurately determine whether or not the map information is incorrect (map inconsistency detection) by performing the above-described comparison between the center lines.

The embodiment described above can be represented as follows.

A travel control device including:

a storage medium storing computer-readable instructions; and

a processor connected to the storage medium, the processor executing the computer-readable instructions to:

recognize a surrounding situation including first markings that define a travel lane of a vehicle on the basis of an output of a detection device that detects a surrounding situation of the vehicle;

recognize second markings that define a lane near the vehicle from map information on the basis of position information of the vehicle;

determine whether or not the first markings match the second markings;

select any one of the first markings and the second markings when it is determined that the first markings do not match the second markings;

execute travel control of the vehicle on the basis of the selected marking; and

compare a center line of a lane defined by the first markings located on left and right sides of the vehicle and a center line of a lane defined by the second markings located on the left and right sides of the vehicle in terms of a degree of deviation therebetween when one of the second markings defining the travel lane of the vehicle and located on the left and right sides of the vehicle is discontinued partway in a travel direction of the vehicle, and select the first markings when the degree of deviation is equal to or greater than a threshold.

Although modes for carrying out the present invention have been described using embodiments, the present invention is not limited to the embodiments and various modifications and substitutions can also be made without departing from the scope and spirit of the present invention.

What is claimed is:

1. A travel control device comprising:
a first recognizer configured to recognize a surrounding situation including first markings that define a travel lane of a vehicle on the basis of an output of a detection device that detects a surrounding situation of the vehicle;
a second recognizer configured to recognize second markings that define a lane near the vehicle from map information on the basis of position information of the vehicle;
a determiner configured to determine whether or not the first markings match the second markings;
a selector configured to select any one of the first markings and the second markings when the determiner determines that the first markings do not match the second markings; and
a travel controller configured to execute travel control of the vehicle on the basis of the marking selected by the selector,
wherein the selector compares a center line of a lane defined by the first markings located on left and right sides of the vehicle and a center line of a lane defined by the second markings located on the left and right sides of the vehicle in terms of a degree of deviation therebetween when one of the second markings defining the travel lane of the vehicle and located on the left and right sides of the vehicle is discontinued partway in a travel direction of the vehicle, and selects the first markings when the degree of deviation is equal to or greater than a threshold.

2. The travel control device according to claim 1, wherein the map information stores information about the center line of the lane defined by the second markings located on the left and right sides of the vehicle for a segment subsequent to a point at which the one of the second markings located on the left and right sides of the vehicle is discontinued partway.

3. The travel control device according to claim 1, wherein the travel lane of the vehicle is a main lane in the map information, and one of the second markings located on the left and right sides of the vehicle continues for a segment subsequent to a point at which the marking is discontinued partway in the travel direction of the vehicle.

4. The travel control device according to claim 1, wherein the travel lane of the vehicle is a lane for which the map information does not include information about a branch lane, a merge lane, or a lane increase/decrease segment.

5. The travel control device according to claim 1, wherein the selector compares the center line of the lane defined by the first markings located on the left and right sides of the vehicle and the center line of the lane defined by the second markings located on the left and right sides of the vehicle in terms of the degree of deviation therebetween, within a detection range of the detection device recognized by the first recognizer.

6. The travel control device according to claim 1, wherein the selector compares the center line of the lane defined by the first markings located on the left and right sides of the vehicle and the center line of the lane defined by the second markings located on the left and right sides of the vehicle in terms of the degree of deviation therebetween, within a range in which the center line of the lane defined by the second markings is not discontinued.

7. The travel control device according to claim 1, wherein the selector compares the center line of the lane defined by the first markings located on the left and right sides of the vehicle and the center line of the lane defined by the second markings located on the left and right sides of the vehicle in terms of the degree of deviation therebetween, when a connection point connected to a merge lane and a connection point connected to a branch lane are located in the travel lane.

8. The travel control device according to claim 7, wherein the selector compares the center line of the lane defined by the first markings located on the left and right sides of the vehicle and the center line of the lane defined by the second markings located on the left and right sides of the vehicle in terms of the degree of deviation therebetween, when a connection point connected to a merge lane is located in the travel direction of the vehicle in the travel lane, and a connection point connected to a branch lane is located within a predetermined distance ahead of the connection point as viewed from the vehicle.

9. A travel control method comprising:
recognizing, by a computer, a surrounding situation including first markings that define a travel lane of a vehicle on the basis of an output of a detection device that detects a surrounding situation of the vehicle;
recognizing, by the computer, second markings that define a lane near the vehicle from map information on the basis of position information of the vehicle;
determining, by the computer, whether or not the first markings match the second markings;
selecting, by the computer, any one of the first markings and the second markings when it is determined that the first markings do not match the second markings;
executing, by the computer, travel control of the vehicle on the basis of the selected marking; and
comparing, by the computer, a center line of a lane defined by the first markings located on left and right sides of the vehicle and a center line of a lane defined by the second markings located on the left and right sides of the vehicle in terms of a degree of deviation therebetween when one of the second markings defining the travel lane of the vehicle and located on the left and right sides of the vehicle is discontinued partway in a travel direction of the vehicle, and selecting the first markings when the degree of deviation is equal to or greater than a threshold.

10. A computer-readable non-transitory storage medium storing a program for causing a computer to:
recognize a surrounding situation including first markings that define a travel lane of a vehicle on the basis of an output of a detection device that detects a surrounding situation of the vehicle;
recognize second markings that define a lane near the vehicle from map information on the basis of position information of the vehicle;
determine whether or not the first markings match the second markings;
select any one of the first markings and the second markings when it is determined that the first markings do not match the second markings;
execute travel control of the vehicle on the basis of the selected marking; and
compare a center line of a lane defined by the first markings located on left and right sides of the vehicle and a center line of a lane defined by the second markings located on the left and right sides of the vehicle in terms of a degree of deviation therebetween when one of the second markings defining the travel lane of the vehicle and located on the left and right sides of the vehicle is discontinued partway in a travel direction of the vehicle, and select the first markings when the degree of deviation is equal to or greater than a threshold.
